(19) United States
(12) Patent Application Publication
(10) Pub. No.: US 2017/0326533 A1
(43) Pub. Date: Nov. 16, 2017

(54) OXYGEN STORAGE CAPACITY OF NON-COPPER SPINEL OXIDE MATERIALS FOR TWC APPLICATIONS

(71) Applicant: Clean Diesel Technologies, Inc., Oxnard, CA (US)

(72) Inventors: Zahra Nazarpoor, Camarillo, CA (US); Stephen J. Golden, Santa Barbara, CA (US)

(21) Appl. No.: 15/499,087

(22) Filed: Apr. 27, 2017

Related U.S. Application Data
(60) Provisional application No. 62/334,605, filed on May 11, 2016.

(51) Int. Cl. B01J 23/889; B01J 37/02; B01J 37/08; C01G 49/00; B01D 53/94; B01J 23/00; F01N 3/10; B01J 21/04; B01J 21/06; B01J 35/00; B01J 23/75; C01G 51/00

(52) U.S. Cl. CPC B01J 23/8892; B01J 37/0236; B01J 37/0242; B01J 37/0244; B01J 37/08; C01G 49/0072; C01G 51/40; B01J 23/005; F01N 3/101; B01J 21/04; B01J 21/066; B01J 35/0006; B01J 23/75; B01D 53/945; B01D 2255/20715; B01D 2255/2073; B01D 2255/20738; B01D 2255/20746; B01D 2255/2092; B01D 2255/405; B01D 2255/9027; B01D 2255/908; C01P 2002/32; F01N 2510/0684; F01N 2370/02

(57) ABSTRACT

Zero-Rare Earth Metal (ZREM) and Zero-platinum group metals (ZPGM) compositions of varied binary spinel oxides are disclosed as oxygen storage material (OSM) to be used within TWC systems. The ZREM-ZPGM OSM systems comprise binary non-Cu spinel oxides of Co—Fe, Fe—Mn, Co—Mn, or Mn—Fe. The oxygen storage capacity (OSC) property associated with the non-Cu ZREM-ZPGM OSM systems is determined employing isothermal OSC oscillating condition testing. Further, the OSC test results compare the OSC properties of a ZREM-ZPGM reference OSM system including a Cu—Mn binary spinel oxide and PGM reference catalysts including Ce-based OSMs. The non-Cu spinel oxides ZREM-ZPGM OSM systems exhibit significantly improved OSC properties, which are greater than the OSC property of the Ce-based OSM PGM reference systems.

### CROSS REFERENCE TO RELATED APPLICATIONS

The present application claims priority to U.S. Provisional Application No. 62/334,605 filed May 11, 2016, the contents of which are hereby incorporated by reference in its entirety.

### BACKGROUND

### Field of the Disclosure

The present disclosure relates generally to oxygen storage materials (OSM), and more specifically, to zero-rare earth metals and zero-platinum group metals (ZREM-ZPGM) systems including spinel oxide compositions.

### Background Information

Conventional gasoline exhaust systems employ three-way catalysts (TWC) technology and are referred to as TWC systems. TWC systems convert the CO, HC, and NO_{X} into less harmful pollutants. Typically, TWC systems include a substrate structure upon which a layer of supporting and sometimes promoting oxides are deposited. Catalysts, based on platinum group metals (PGM), are then deposited upon the supporting oxides. Conventional PGM materials include platinum (Pt), palladium (Pd), rhodium (Rh), iridium (Ir), or combinations thereof. Some conventional TWC systems have been developed to incorporate an oxygen storage material (OSM), mostly based on rare-earth (RE) metal oxides, which stores oxygen during the leaner periods of the engine operating cycle and then releases the stored oxygen during the richer periods of the engine operating cycle.

Although PGM/RE metal oxide based-OSM are effective for toxic emission control and have been commercialized by the emissions control industry, PGM/RE metal oxide based-OSM are scarce and expensive. The high cost remains a critical factor for widespread employment of PGM/RE metal oxide based-OSM. As changes in the formulation of catalysts continue to increase the cost of TWC converters, the need for catalysts of significant catalytic performance has directed efforts toward the development of catalytic materials capable of providing the required synergies to achieve greater catalytic performance. Additionally, compliance with ever stricter environmental regulations, and the need for lower manufacturing costs require new types of TWC systems. Therefore, there is a continuing need to provide TWC systems free of PGM/RE metal oxide based-OSM that exhibit catalytic properties substantially similar to or exceeding the catalytic properties exhibited by conventional TWC systems employing PGM/RE metal oxide based-OSM.

### SUMMARY

The present disclosure relates to zero-rare earth metals and zero-platinum group metals (ZREM-ZPGM) oxygen storage materials (OSM) including non-copper (Cu) binary spinel oxide compositions, herein referred to as ZREM-ZPGM Type 1, Type 2, Type 3, and Type 4 OSM systems, which can be produced using any conventional synthesis methodology. Further, the present disclosure describes a process for identifying the oxygen storage capacity (OSC) property of the aforementioned ZREM-ZPGM OSM systems. In some embodiments, the O₂ and CO delay times of the aforementioned ZREM-ZPGM OSM systems are compared with a ZREM-ZPGM OSM reference system including a copper (Cu)-manganese (Mn) binary spinel structure as well as PGM OSM reference systems.

In some embodiments, the ZREM-ZPGM spinel oxide composition is expressed with a general formulation of A_{X}B_{3-X}O₄ in which X is a variable for molar ratios within a range from about 0.01 to about 2.99. In other embodiments, the ZREM-ZPGM spinel oxide composition is impregnated as impregnation layer onto support oxides, such as, for example, alumina, doped alumina, zirconia, doped zirconia, titania, doped titania, and mixture thereof. In these embodiments, A and B can be implemented as aluminum, magnesium, manganese, gallium, nickel, silver, cobalt, iron, chromium, titanium, tin, strontium, or mixtures thereof. In an example, the spinel oxide composition includes Co_{X}Fe_{3-X}O₄. In another example, the spinel composition includes Fe_{X}Mn_{3-X}O₄. In a further example, the spinel composition includes Co_{X}Mn_{3-X}O₄. In a yet further example, the non-Cu spinel ZREM-ZPGM OSM systems include Mn—Fe binary spinel structures with a general formulation of Mn_{X}Fe_{3-X}O₄.

In some embodiments, the OSC properties of the aforementioned ZREM-ZPGM OSM systems, the ZREM-ZPGM OSM reference system, and the PGM OSM reference systems are determined employing isothermal OSC oscillating condition testing. In these embodiments, the O₂ and CO delay times of aforementioned ZREM-ZPGM OSM systems are determined to assess the oxygen storage capacity (OSC) of a non-Cu binary spinel structure. Further to these embodiments, the ZREM-ZPGM OSM systems exhibit significantly improved OSC properties as compared to PGM OSM reference systems.

In one embodiment, the disclosure is directed to a catalyst composition comprising a spinel oxide having the formula A_{X}B_{3-X}O₄ where X is from about 0.001 to about 2.99, A and B are different from each other and selected from the group consisting of aluminum (Al), magnesium (Mg), manganese (Mn), gallium (Ga), nickel (Ni), silver (Ag), cobalt (Co), iron (Fe), chromium (Cr), titanium (Ti), tin (Sn), strontium (Sr), and mixtures thereof, and wherein the composition is characterized by the absence of a copper (Cu) containing spinel.

In some embodiments, the catalyst composition is free of platinum group metals, and is free of rare earth metals.

In one embodiment, the spinel oxide is selected from the group consisting of Co—Fe binary spinel structures, Fe—Mn binary spinel structures, Co—Mn binary spinel structures, Mn—Fe binary spinel structures, and combinations thereof. Examples of preferred spinel oxides include Co_{0.2}Fe_{2.8}O₄, Fe_{1.0}Mn_{2.0}O₄, Co_{1.0}Mn_{2.0}O₄, Mn_{0.5}Fe_{2.5}O₄, and combinations thereof.

Advantageously, catalyst compositions in accordance with embodiments of the disclosure may exhibit a CO delay time that is between 10 and 45 seconds. In some embodiments, the catalyst composition may exhibit an O₂ delay time that is between 25 and 40 seconds.

In a further aspect of the disclosure, a catalyst system is provided. In one embodiment, the catalyst system comprises a substrate; at least one washcoat layer deposited onto the substrate, the washcoat layer comprising a support oxide material; at least on overcoat layer overlying the at least one washcoat layer, wherein the overcoat layer comprises a support oxide material; and an impregnation layer that is at least partially impregnated onto an underlying overcoat layer. Preferably, the impregnation layer comprises a catalyst composition comprising a spinel oxide having the formula A_{X}B_{3-X}O₄ where X is from about 0.001 to about 2.99, A and B are different from each other and are selected from the group consisting of aluminum (Al), magnesium (Mg), manganese (Mn), gallium (Ga), nickel (Ni), silver (Ag), cobalt (Co), iron (Fe), chromium (Cr), titanium (Ti), tin (Sn), strontium (Sr), and mixtures thereof, and wherein the composition is characterized by the absence of copper (Cu) containing spinel.

In one embodiment, the spinel oxide of the catalyst system is selected from the group consisting of Co—Fe binary spinel structures, Fe—Mn binary spinel structures, Co—Mn binary spinel structures, and combinations thereof. For example, the spinel oxide may be selected from the group consisting of Co_{0.2}Fe_{2.8}O₄, Fe_{1.0}Mn_{2.0}O₄, Co_{1.0}Mn_{2.0}O₄, and combinations thereof. Preferably, the catalyst composition of the catalyst system is free of platinum group metals, and is free of rare earth metals.

In some embodiments, the support oxides in the at least one overcoat layer and the at least one washcoat layer are selected from the group consisting of Al₂O₃, doped Al₂O₃, ZrO₂, doped ZrO₂, SiO₂, doped SiO₂, TiO₂, doped TiO₂, doped Al₂O₃—ZrO₂, and mixtures thereof. In addition, in some embodiments of the disclosure the support is doped with an oxide selected from the group consisting of La₂O₃, CeO₂, Pr₂O₃, TiO₂, Nb₂O₃, and mixtures thereof.

In one embodiment of the catalyst system, the washcoat layer comprises doped Al₂O₃, the overcoat layer comprises doped Zr₂O₂, and the spinel oxide is Co_{0.2}Fe_{2.8}O₄. In another embodiment of the catalyst system, the washcoat layer comprises doped Al₂O₃, the overcoat layer comprises doped Zr₂O₂, and the spinel oxide is Fe_{1.0}Mn_{2.0}O₄. In yet another embodiment of the catalyst system, the washcoat layer comprises doped Al₂O₃, the overcoat layer comprises doped Zr₂O₂, and the spinel oxide is Co_{1.0}Mn_{2.0}O₄.

In one embodiment, the catalyst system exhibits a CO delay time that is between 10 and 25 seconds, and an O₂ delay time that is between 25 and 40 seconds. In some embodiments, the catalyst system exhibits a CO delay time that is between 11 and 25 seconds, and an O₂ delay time that is between 27 and 39 seconds.

Catalyst compositions and systems in accordance with some embodiments of the invention may be prepared via one or more of co-precipitation, nitrate combustion, impregnation, sol-gel, incipient wetness, or similar methodologies.

In one embodiment, a catalyst composition comprising a Mn—Fe binary spinel oxide composition that is characterized by the absence of a copper (Cu) containing spinel is provided. For example, the Mn—Fe binary spinel oxide in the catalyst composition may be Mn_{0.5}Fe_{2.5}O₄. In some embodiments, the catalyst composition comprises a mixture of the Mn—Fe binary spinel oxide and a doped Al₂O₃—ZrO₂ support oxide. In some embodiments, the catalyst composition comprising a Mn—Fe binary spinel oxide may exhibit a CO delay time that is between 24 and 38 seconds.

Numerous other aspects, features, and benefits of the present disclosure may be made apparent from the following detailed description taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a graphical representation illustrating a system configuration for zero-rare earth metals and zero-platinum group metals (ZREM-ZPGM) oxygen storage material (OSM) systems, according to an embodiment.

FIG. 2 is a graphical representation illustrating oxygen storage capacity (OSC) isothermal oscillating test results of O₂ delay times for fresh ZREM-ZPGM Type 1, Type 2, and Type 3 OSM systems as well as for a ZREM-ZPGM OSM reference system, at about 575° C. and space velocity (SV) of about 60,000 h⁻¹, according to an embodiment.

FIG. 3 is a graphical representation illustrating OSC isothermal oscillating test results of CO delay times for fresh ZREM-ZPGM Type 1, Type 2, and Type 3 OSM systems as well as for a ZREM-ZPGM OSM reference system, at about 575° C. and SV of about 60,000 h⁻¹, according to an embodiment.

FIG. 4 is a graphical representation illustrating OSC isothermal oscillating test results of CO delay times for fresh ZREM-ZPGM Type 4 OSM systems A, B, C, D, and E as well as for a OSM reference system 2, at about 525° C. and SV of about 60,000 h⁻¹, according to an embodiment.

FIG. 5 is a graphical representation illustrating OSC isothermal oscillating test results of CO delay times for fresh and aged ZREM-ZPGM Type 4 OSM system B, at about 525° C. and SV of about 60,000 h⁻¹, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms have the following definitions:

“Calcination” refers to a thermal treatment process applied to solid materials, in presence of air, to bring about a thermal decomposition, phase transition, or removal of a volatile fraction at temperatures below the melting point of the solid materials.

“CO delay time” refers to the time required to reach to 50% of the CO concentration in feed signal during an OSC isothermal oscillating test.

“Impregnation” refers to the process of imbuing or saturating a solid layer surface with a liquid compound or the diffusion of some element through a medium or substance.

“Milling” refers to the operation of breaking a solid material into a desired grain or particle size.

“O₂ delay time” refers to the time required to reach to 50% of the O₂ concentration in feed signal during an OSC isothermal oscillating test.

“Overcoat (OC) layer” refers to a layer of at least one coating that can be deposited onto at least one washcoat layer or impregnation layer.

“Oxygen storage capacity (OSC)” refers to the property of materials used as OSM in catalysts to store oxygen at lean conditions and to release it at rich conditions.

“Oxygen storage material (OSM)” refers to a material that takes up oxygen from oxygen rich streams, and further release oxygen to oxygen deficient streams.

“Platinum group metals (PGM)” refers to platinum, palladium, ruthenium, iridium, osmium, and rhodium.

“Spinel” refers to any minerals of the general formulation AB₂O₄ where the A ion and B ion are each selected from mineral oxides, such as, for example magnesium, iron, zinc, manganese, aluminum, chromium, titanium, cobalt, nickel, or copper, amongst others.

“Substrate” refers to any material of any shape or configuration that yields a sufficient surface area for depositing a washcoat and/or overcoat.

“Support oxide” refers to porous solid oxides, typically mixed metal oxides, which are used to provide a high surface area that aids in oxygen distribution and exposure of catalysts to reactants, such as, for example NO_{X}, CO, and hydrocarbons.

“Three-Way Catalyst (TWC)” refers to a catalyst that performs the three simultaneous tasks of reduction of nitrogen oxides, oxidation of carbon monoxide, as well as oxidation of unburnt hydrocarbons.

“Washcoat (WC) layer” refers to a layer of at least one coating that can be deposited onto a substrate.

“Zero-Rare Earth Metals (ZPGM)” refers to a material free of rare-earth (RE) metals.

“Zero-platinum group metals (ZPGM)” refers to a material free of platinum group metals (PGM).

### DESCRIPTION OF THE DISCLOSURE

The present disclosure relates to zero-rare earth metals-zero-platinum group metals (ZREM-ZPGM) oxygen storage materials (OSM) systems including non-Cu binary spinel oxide compositions, which can be produced using any conventional synthesis methodology (e.g., co-precipitation, nitrate combustion, impregnation, sol-gel, and incipient wetness, amongst others). Further, the present disclosure describes a process for identifying the oxygen storage capacity (OSC) property of the aforementioned ZREM-ZPGM OSM systems. In some embodiments, the O₂ and CO delay times of aforementioned ZREM-ZPGM OSM systems are compared with ZREM-ZPGM OSM reference system including copper (Cu)-manganese (Mn) binary spinel oxide compositions as well as PGM OSM reference systems.

ZREM-ZPGM OSM System Configuration, Material Composition, and Preparation

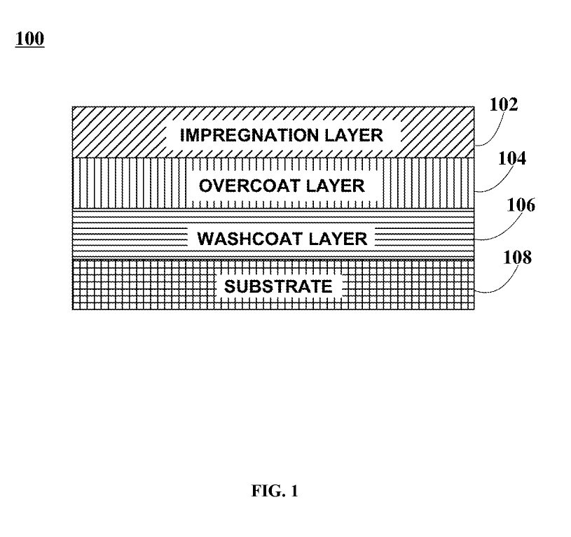

FIG. 1 is a graphical representation illustrating a system configuration for zero-rare earth metals and zero-platinum group metals (ZREM-ZPGM) oxygen storage material (OSM) systems, according to an embodiment. In FIG. 1, ZREM-ZPGM OSM configuration system 100 includes impregnation (IMP) layer 102, overcoat (OC) layer 104, washcoat (WC) layer 106, and substrate 108. In FIG. 1, WC layer 106 is deposited onto substrate 108, OC layer 104 is deposited onto WC layer 106, and IMP layer 102 is impregnated onto OC layer 104.

In some embodiments, the WC and OC layers are implemented within ZREM-ZPGM OSM systems as support oxides. Examples of support oxide materials employed in the production of the WC and OC layers include Al₂O₃, doped Al₂O₃, ZrO₂, doped ZrO₂, SiO₂, doped SiO₂, TiO₂, doped TiO₂, doped Al₂O₃—ZrO₂ or mixtures thereof, amongst others. In an example, the support oxide used within the WC layer is doped Al₂O₃. In this example, the support oxide used within the OC layer is doped ZrO₂.

In some embodiments, the IMP layers include varied binary spinel structures expressed with a general formulation of A_{X}B_{3-X}O₄ in which X is a variable for molar ratios within a range from about 0.01 to about 2.99. In these embodiments, A and B can be implemented as aluminum, magnesium, manganese, gallium, nickel, silver, cobalt, iron, chromium, titanium, tin, strontium or mixtures thereof. Further to these embodiments, the IMP layers are implemented as non-Cu binary spinel structures.

In an example, the non-Cu spinel ZREM-ZPGM OSM systems include Co—Fe binary spinel structures with a general formulation of Co_{X}Fe_{3-X}O₄ in which X takes the value of about 0.2 resulting in a Co_{0.2}Fe_{2.8}O₄ spinel. In another example, the non-Cu spinel ZREM-ZPGM OSM systems include Fe—Mn binary spinel structures with a general formulation of Fe_{X}Mn_{3-X}O₄ in which X takes a value of about 1.0 resulting in a Fe_{1.0}Mn_{2.0}O₄ spinel. In a further example, the non-Cu spinel ZREM-ZPGM OSM systems include Co—Mn binary spinel structures with a general formulation of Co_{X}Mn_{3-X}O₄ in which X takes a value of about 1.0 resulting in a Co_{1.0}Mn_{2.0}O₄ spinel. In a yet further example, the non-Cu spinel ZREM-ZPGM OSM systems include Mn—Fe binary spinel structures with a general formulation of Mn_{X}Fe_{3-X}O₄ in which X takes a value of about 0.5 resulting in a Mn_{0.5}Fe_{2.5}O₄ spinel.

In other embodiments, the IMP layers are implemented as Cu—Mn binary spinel structures with a general formulation of Cu_{X}Mn_{3-X}O₄ in which X takes a value of about 1.0 resulting in a Cu_{1.0}Mn_{2.0}O₄ spinel composition. In these embodiments, Cu—Mn binary spinel oxides are employed to produce the ZREM-ZPGM OSM reference system.

ZREM-ZPGM Type 1 OSM Systems: Co—Fe Spinel Structure

In some embodiments, a ZREM-ZPGM OSM system, herein referred to as ZREM-ZPGM Type 1 OSM system, includes a WC layer of doped Al₂O₃ support oxide deposited onto a substrate, an OC layer of doped ZrO₂ support oxide deposited onto the WC layer, and an IMP layer comprising a Co—Fe binary spinel oxide composition impregnated onto the OC layer.

In these embodiments, the preparation of the WC layer begins by milling doped Al₂O₃ with water to produce aqueous slurry of doped Al₂O₃, which is coated onto the substrate layer and further dried and calcined at about 550° C. for about 5 hours. Further to these embodiments, the preparation of the OC layer begins by milling doped ZrO₂ with water to produce aqueous slurry of doped ZrO₂. Still further to these embodiments, the slurry of doped ZrO₂ is coated onto the WC layer and further dried and calcined at about 550° C. for about 5 hours. In these embodiments, the production of the IMP layer begins by mixing the appropriate amount of Co nitrate solution and Fe nitrate solution to produce a solution at an appropriate molar ratio of Co_{0.2}Fe_{2.8}O₄, expressed as the general formulation of Co_{X}Fe_{3-X}O₄ in which X takes a value of about 0.2. Further to these embodiments, the Co—Fe solution is then impregnated onto the OC layer, and is further dried and calcined at a temperature within a range from about 600° C. to about 900° C., preferably about 800° C., for about 5 hours.

ZREM-ZPGM Type 2 OSM Systems: Fe—Mn Spinel Structure

In some embodiments, a ZREM-ZPGM OSM system, herein referred to as ZREM-ZPGM Type 2 OSM system, includes a WC layer of doped Al₂O₃ support oxide deposited onto a substrate, an OC layer of doped ZrO₂ support oxide deposited onto the WC layer, and an IMP layer comprising a Fe—Mn binary spinel oxide composition impregnated onto the OC layer.

In these embodiments, the production of the ZREM-ZPGM Type 2 OSM system begins with the preparation of the WC and OC layers, which are produced using the same material compositions and preparation methods as previously described above for the ZREM-ZPGM Type 1 OSM system. Further to these embodiments, the production of the IMP layer begins by mixing the appropriate amount of Fe nitrate solution and Mn nitrate solution to produce a solution at an appropriate molar ratio of Fe_{1.0}Mn_{0.2}O₄, expressed as the general formulation of Fe_{X}Mn_{3-X}O₄ in which X takes a value of about 1.0. In these embodiments, the Fe—Mn solution is then impregnated on the OC layer, and is further dried and calcined at a temperature within a range from about 600° C. to about 900° C., preferably about 800° C., for about 5 hours.

ZREM-ZPGM Type 3 OSM Systems: Co—Mn Spinel Structure

In some embodiments, a ZREM-ZPGM catalyst system, herein referred to as ZREM-ZPGM Type 3 OSM system, includes a WC layer of doped Al₂O₃ support oxide deposited onto a substrate, an OC layer of doped ZrO₂ support oxide deposited onto the WC layer, and an IMP layer comprising a Co—Mn binary spinel oxide composition impregnated onto the OC layer.

In these embodiments, the production of the ZREM-ZPGM Type 3 OSM system begins with the preparation of the WC and OC layers, which are produced using the same material compositions and preparation methods as previously described above for the ZREM-ZPGM Type 1 OSM system. Further to these embodiments, the production of the IMP layer begins by mixing the appropriate amount of Co nitrate solution and Mn nitrate solution with water to produce a solution of Co_{1.0}Mn_{0.2}O₄, expressed as the general formulation of Co_{X}Mn_{3-X}O₄ in which X takes a value of about 1.0. In these embodiments, the Co—Mn solution is then impregnated on the OC layer, and is further dried and calcined at a temperature within a range from about 600° C. to about 900° C., preferably about 800° C., for about 5 hours.

ZREM-ZPGM Type 4 OSM Systems: Mn—Fe Spinel Structure

In some embodiments, a ZREM-ZPGM catalyst system, herein referred to as ZREM-ZPGM Type 4 OSM system, includes a bulk powder Mn—Fe binary spinel oxide composition. In other embodiments, the bulk powder Mn—Fe binary spinel oxide composition is mixed with a doped Al₂O₃—ZrO₂ support oxide using different mixing ratios (% wt).

In these embodiments, the production of the bulk powder Mn—Fe binary spinel oxide composition begins by preparing a Mn—Fe solution. Further to these embodiments, the Mn—Fe solution is prepared by mixing an appropriate amount of Mn nitrate solution and Fe nitrate solution with water to produce a mixed metal nitrate solution at a specific molar ratio according to the formulation Mn_{X}Fe_{3-X}O₄, where X takes a value of about 0.5 for Mn_{0.5}Fe_{2.5}O₄. Still further to these embodiments, the Mn—Fe nitrate solution is precipitated with an appropriate base solution, such as, for example sodium hydroxide (NaOH) solution, sodium carbonate (Na₂CO₃) solution, ammonium hydroxide (NH₄OH) solution, tetraethyl ammonium hydroxide (TEAH) solution, amongst others, to adjust the pH of the solution at suitable values (e.g., pH=8-11). In these embodiments, the precipitated material of Mn—Fe spinel is dried at about 120° C. overnight, and further calcined at a temperature within a range from about 600° C. to about 850° C., preferably about 800° C., for about 5 hours. Further to these embodiments, the calcined Mn—Fe binary spinel oxide is subsequently ground into fine powder. In other embodiments, the bulk powder Mn—Fe binary spinel oxide can be produced using any conventional synthesis methodology (e.g., nitrate combustion, impregnation, sol-gel and incipient wetness, amongst others).

In some embodiments, ZREM-ZPGM Type 4 OSM systems A, B, C, D, and E are produced by mixing bulk powder Mn—Fe binary spinel oxide composition with the doped Al₂O₃—ZrO₂ support oxide using different mixing ratios (% wt), as illustrated below in Table 1.

TABLE 1
List of ZREM-ZPGM Type 4 OSM systems.

| ZREM-ZPGM | | |
|---|---|---|
| TYPE 4 OSM | BULK POWDER | |
| SYSTEM | COMPOSITION | RATIO |
| A | Mn_{0.5}Fe_{2.5}O₄ | — |
| B | Mn_{0.5}Fe_{2.5}O₄:doped Al₂O₃—ZrO₂ | 90:10 |
| C | Mn_{0.5}Fe_{2.5}O₄:doped Al₂O₃—ZrO₂ | 75:25 |
| D | Mn_{0.5}Fe_{2.5}O₄:doped Al₂O₃—ZrO₂ | 60:40 |
| E | Mn_{0.5}Fe_{2.5}O₄:doped Al₂O₃—ZrO₂ | 50:50 |

In some embodiments, ZREM-ZPGM Type 4 OSM system B is aged under a 4-mode aging cycle protocol. In these embodiments, ZREM-ZPGM Type 4 OSM system B is aged under the 4-mode aging cycle protocol at a bed temperature of about 1000° C. for about 5 hours.

In other embodiments, ZREM-ZPGM Type 4 OSM systems A, B, C, D, and E can be produced using any conventional synthesis methodology (e.g., co-precipitation, nitrate combustion, impregnation, sol-gel, and incipient wetness, amongst others) and achieve substantially similar mixing ratios (bulk powder:support oxide).

ZREM-ZPGM OSM Reference Systems: Cu—Mn Spinel Structure

In some embodiments, a ZREM-ZPGM OSM system, herein referred to as ZREM-ZPGM OSM reference system, includes a WC layer of doped Al₂O₃ support oxide deposited onto a substrate, an OC layer of doped ZrO₂ support oxide deposited onto the WC layer, and an IMP layer comprising a Cu—Mn binary spinel oxide composition impregnated onto the OC layer.

In these embodiments, the production of the ZREM-ZPGM OSM reference system begins with the preparation of the WC and OC layers, which are produced using the same material compositions and preparation methods as previously described above for the ZREM-ZPGM Type 1 OSM system. Further to these embodiments, the production of the IMP layer begins by mixing the appropriate amount of Cu nitrate solution and Mn nitrate solution with water to produce a solution of Cu_{1.0}Mn_{0.2}O₄, expressed as the general formulation of Cu_{X}Mn_{3-X}O₄ in which X takes a value of about 1.0. In these embodiments, the Cu—Mn solution is then impregnated onto the OC layer, and is further dried and calcined at a temperature within a range from about 600° C. to about 900° C., preferably about 800° C., for about 5 hours.

PGM OSM Reference Systems

In some embodiments, a PGM OSM reference system 1 comprises a commercial PGM catalyst with Pd loadings of about 20 g/ft³ and a ceria-based OSM, with loadings in a range from about 30% by weight to about 50% by weight. In other embodiments, a PGM OSM reference system 2 comprises a PGM catalyst with Pd loadings of about 10 g/ft³ and a ceria/zirconia-based OSM.

In some embodiments, OSC isothermal oscillating tests are performed to assess the OSC properties of fresh ZREM-ZPGM Type 1, Type 2, Type 3, and Type 4 OSM systems, ZREM-ZPGM OSM reference system, and PGM OSM reference systems. In other embodiments, OSC isothermal oscillating tests are performed to assess the OSC properties of aged ZREM-ZPGM Type 4 OSM system B.

OSC Isothermal Oscillating Test Procedure

In some embodiments, OSC isothermal oscillating tests facilitate the determination of the O₂ and CO delay times for a selected number of cycles during which feed signals of O₂ and CO pulses are used to determine/verify the OSC property of ZREM-ZPGM Type 1, Type 2, Type 3, and Type 4 OSM systems, a ZREM-ZPGM OSM reference system, and a PGM OSM reference system. In these embodiments, the CO and O₂ delay times resulting for aforementioned OSM systems are compared to assess the OSC property resulting from the cooperative behavior between the components within ZREM-ZPGM Type 1, Type 2, Type 3, and Type 4 OSM systems. Further to these embodiments, the OSC isothermal oscillating tests are performed on the aforementioned OSM systems at temperatures of about 525° C. and about 575° C. with a feed of either O₂ with a concentration of about 4,000 ppm diluted in inert nitrogen (N₂), or CO with a concentration of about 8,000 ppm of CO diluted in inert N₂. Still further to these embodiments, the OSC isothermal oscillating tests are performed within a quartz reactor using a space velocity (SV) of 60,000 h⁻¹, ramping from room temperature to a temperature of about 525° C. or about 575° C. under a dry N₂ environment. When the temperature of about 525° C. or about 575° C. is reached, the OSC isothermal oscillating test is initiated by flowing O₂ through the catalyst sample within the reactor. After about 240 seconds, the feed flow is switched to CO, thereby allowing CO to flow through the OSM system within the reactor for another 240 seconds. The isothermal oscillating condition between CO and O₂ flows is enabled for about 4 cycles of about 480 seconds each, respectively.

In these embodiments, O₂ and CO are allowed to flow first within an empty test reactor, before the OSC isothermal oscillating test of the OSM systems. Then, an OSM system under testing is placed within the test reactor and O₂ and CO are allowed to flow. As the OSM system can exhibit OSC property, the OSM system can store O₂ when O₂ flows. When CO flows, there is no O₂ flowing, and the O₂ stored within the OSM system can react with the CO to form CO₂. Further to these embodiments, the time during which the OSM system stores O₂ and the time during which CO is oxidized to form CO₂ are measured to confirm/verify the OSC property of the OSM systems and compare the O₂ and CO delay time results for the ZREM-ZPGM Type 1, Type 2, Type 3, and Type 4 OSM systems, the ZREM-ZPGM OSM reference system, and the PGM OSM reference system.

OSC Property of ZREM-ZPGM OSM Systems Including Binary Spinel Oxide Structures

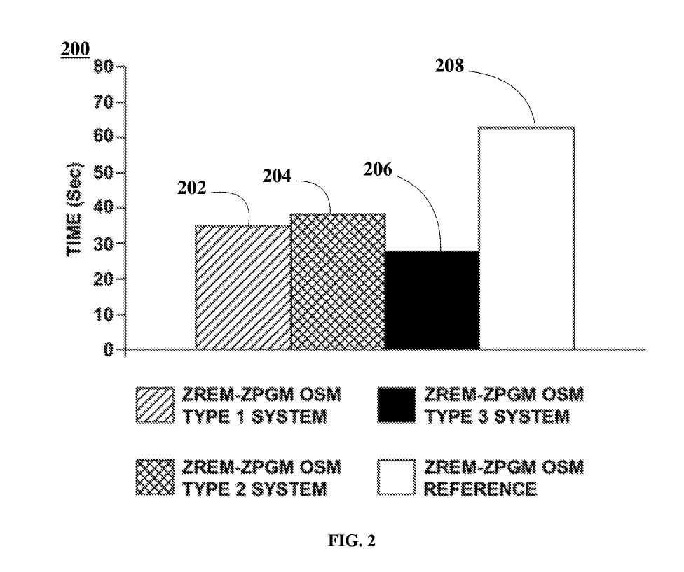

FIG. 2 is a graphical representation illustrating oxygen storage capacity (OSC) isothermal oscillating test results of O₂ delay times for fresh ZREM-ZPGM Type 1, Type 2, and Type 3 OSM systems as well as for a ZREM-ZPGM OSM reference system, at about 575° C. and space velocity (SV) of about 60,000 h⁻¹, according to an embodiment. In FIG. 2, OSC test results 200 include O₂ delay time bar 202, O₂ delay time bar 204, O₂ delay time bar 206, and O₂ delay time bar 208.

In some embodiments, O₂ delay time bar 202 illustrates O₂ delay time associated with ZREM-ZPGM Type 1 OSM system. In these embodiments, O₂ delay time bar 204 illustrates O₂ delay time associated with ZREM-ZPGM Type 2 OSM system. Further to these embodiments, O₂ delay time bar 206 illustrates O₂ delay time associated with ZREM-ZPGM Type 3 OSM system. Still further to these embodiments, O₂ delay time bar 208 illustrates O₂ delay time associated with ZREM-ZPGM OSM reference system.

In some embodiments, as observed in FIG. 2 and Table 2 below, the measured O₂ delay times for fresh ZREM-ZPGM Type 1, Type 2, and Type 3 OSM systems are about 34.90, 38.16, and 27.85 seconds, respectively. In these embodiments the measured O₂ delay times for ZREM-ZPGM OSM reference system is about 62.70 seconds. Further to these embodiments, the OSC test results indicate oxygen storage capacity (OSC) within the fresh ZREM-ZPGM Type 1, Type 2, and Type 3 OSM systems. Still further to these embodiments, ZREM-ZPGM Type 2 OSM system exhibits the highest O₂ delay time when compared with the ZREM-ZPGM Type 1 and Type 3 OSM systems. In these embodiments, aforementioned non-Cu spinel ZREM-ZPGM OSM systems exhibit lower O₂ delay times compared to the O₂ delay times of the ZREM-ZPGM OSM reference system, but greater than the O₂ delay time of about 19.20 seconds exhibited by the PGM OSM reference system 1, which includes 30-50 wt % Ce-based OSM. These results confirm that aforementioned non-Cu spinel OSM systems provide improved OSC performance when compared with the PGM OSM reference system 1 and can be employed within a variety of TWC applications.

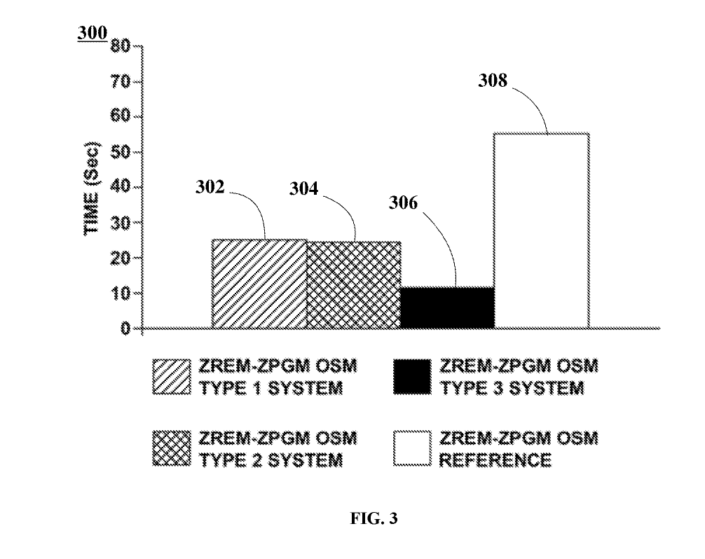

FIG. 3 is a graphical representation illustrating OSC isothermal oscillating test results of CO delay times for fresh ZREM-ZPGM Type 1, Type 2, and Type 3 OSM systems as well as for a ZREM-ZPGM OSM reference system, at about 575° C. and SV of about 60,000 h⁻¹, according to an embodiment. In FIG. 3, OSC test results 300 include CO delay time bar 302, CO delay time bar 304, CO delay time bar 306, and CO delay time bar 308.

In some embodiments, CO delay time bar 302 illustrates CO delay time associated with ZREM-ZPGM Type 1 OSM system. In these embodiments, CO delay time bar 304 illustrates CO delay time associated with ZREM-ZPGM Type 2 OSM system. Further to these embodiments, CO delay time bar 306 illustrates CO delay time associated with ZREM-ZPGM Type 3 OSM system. Still further to these embodiments, CO delay time bar 308 illustrates CO delay time associated with ZREM-ZPGM OSM reference system.

In some embodiments, as observed in FIG. 3 and Table 2 below, the measured CO delay times for fresh ZREM-ZPGM Type 1, Type 2, and Type 3 OSM systems are about 24.33, 24.11, and 11.64 seconds, respectively. In these embodiments, the measured CO delay times for ZREM-ZPGM OSM reference system is about 55.30 seconds. Further to these embodiments, ZREM-ZPGM Type 1 and Type 2 OSM systems exhibit substantially similar CO delay times. Still further to these embodiments, ZREM-ZPGM Type 1 and Type 2 OSM systems exhibit higher CO delay times when compared with ZREM-ZPGM Type 3 OSM system. In these embodiments, aforementioned non-Cu spinel ZREM-ZPGM OSM systems exhibit lower CO delay times compared to the CO delay times of the ZREM-ZPGM OSM reference system, but greater than the CO delay time of about 18.80 seconds exhibited by the PGM OSM reference system 1, which includes 30-50 wt % Ce-based OSM. These results confirm that aforementioned non-Cu spinel OSM systems provide improved OSC performance when compared with PGM OSM reference system 1 and can be employed within a variety of TWC applications.

TABLE 2
O₂ and CO delay times for ZREM-ZPGM Type 1, Type 2, and
Type 3 OSM systems as well for the ZREM-ZPGM OSM
reference system and the PGM OSM reference system 1.

| | FRESH CONDITION | |
|---|---|---|
| | O₂ DELAY | CO DELAY |
| SAMPLE | TIME (Sec) | TIME (Sec) |
| PGM-OSM REFERENCE SYSTEM | 19.20 | 18.80 |
| ZREM-ZPGM TYPE 1 OSM SYSTEM | 34.91 | 24.33 |
| ZREM-ZPGM TYPE 2 OSM SYSTEM | 38.16 | 24.11 |
| ZREM-ZPGM TYPE 3 OSM SYSTEM | 27.85 | 11.64 |
| ZREM-ZPGM OSM REFERENCE | 62.70 | 55.30 |
| SYSTEM 1 | | |

In summary, ZREM-ZPGM Type 1, Type 2, and Type 3 OSM systems exhibit significantly improved OSC properties as compared to the OSC property associated with the PGM OSM reference system 1 including Ce-based OSM. Although the OSC property of the aforementioned ZREM-ZPGM OSM systems is lower than the OSC property of the ZREM-ZPGM OSM reference system including Cu—Mn binary spinel oxide, the OSC property of the aforementioned ZREM-ZPGM OSM including non-Cu spinel oxides are greater than the OSC property of the conventional PGM OSM reference system 1 including Ce-based OSM. The OSC test results confirm that the improved OSC properties of ZREM-ZPGM Type 1, Type 2, and Type 3 systems are attributed to the binary spinel oxides of Co—Fe, Fe—Mn, and Co—Mn, respectively. The aforementioned results confirm that non-Cu spinel ZREM-ZPGM OSM systems can be employed as OSM within a variety of TWCs.

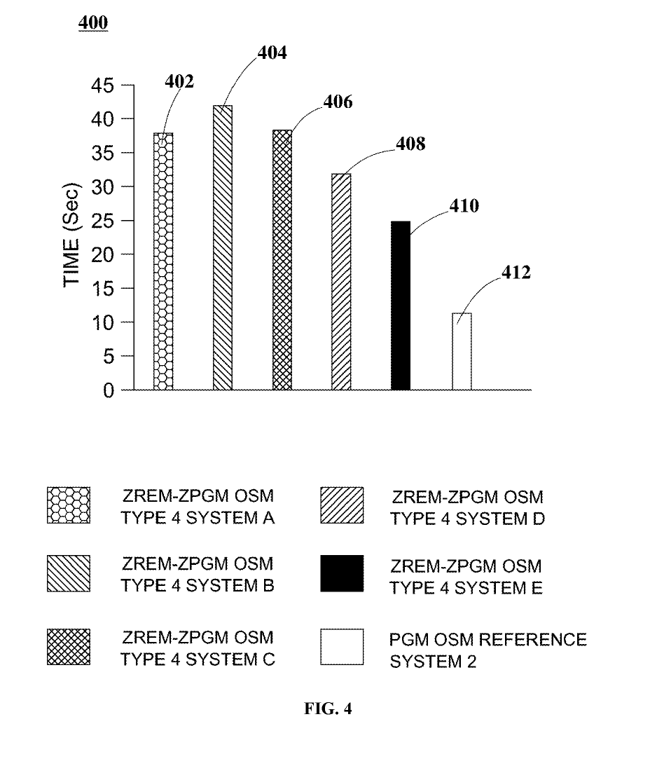

FIG. 4 is a graphical representation illustrating OSC isothermal oscillating test results of CO delay times for fresh ZREM-ZPGM Type 4 OSM systems A, B, C, D, and E as well as for a OSM reference system 2, at about 525° C. and SV of about 60,000 h⁻¹, according to an embodiment. In FIG. 4, OSC test results 400 includes CO delay time bar 402, CO delay time bar 404, CO delay time bar 406, CO delay time bar 408, CO delay time bar 410, and CO delay time bar 412.

In some embodiments, CO delay time bar 402 illustrates CO delay time associated with ZREM-ZPGM Type 4 OSM system A. In these embodiments, CO delay time bar 404 illustrates CO delay time associated with ZREM-ZPGM Type 4 OSM system B. Further to these embodiments, CO delay time bar 406 illustrates CO delay time associated with ZREM-ZPGM Type 4 OSM system C. Still further to these embodiments, CO delay time bar 408 illustrates CO delay time associated with ZREM-ZPGM Type 4 OSM system D. In these embodiments, CO delay time bar 410 illustrates CO delay time associated with ZREM-ZPGM Type 4 OSM system E. Further to these embodiments, CO delay time bar 412 illustrates CO delay time associated with OSM reference system 2.

In some embodiments, the measured CO delay times for fresh ZREM-ZPGM Type 4 OSM systems A, B, C, D, and E are about 37.91, 41.99, 38.33, 31.87, and 24.88 seconds, respectively. In these embodiments, the measured CO delay times for OSM reference system 2 is about 11.23 seconds. Further to these embodiments, ZREM-ZPGM Type 4 OSM systems A and C exhibit substantially similar CO delay times. Still further to these embodiments, ZREM-ZPGM Type 4 OSM system B exhibits the highest CO delay time when compared with the ZREM-ZPGM Type 4 OSM systems A, C, D, and E. In these embodiments, aforementioned non-Cu spinel ZREM-ZPGM Type 4 OSM systems exhibit greater CO delay times compared to the CO delay times of the OSM reference system 2 (including ceria/zirconia-based OSM), thereby confirming that aforementioned non-Cu spinel OSM systems provide improved OSC performance when compared with PGM OSM reference system 2 and can be employed within a variety of TWC applications.

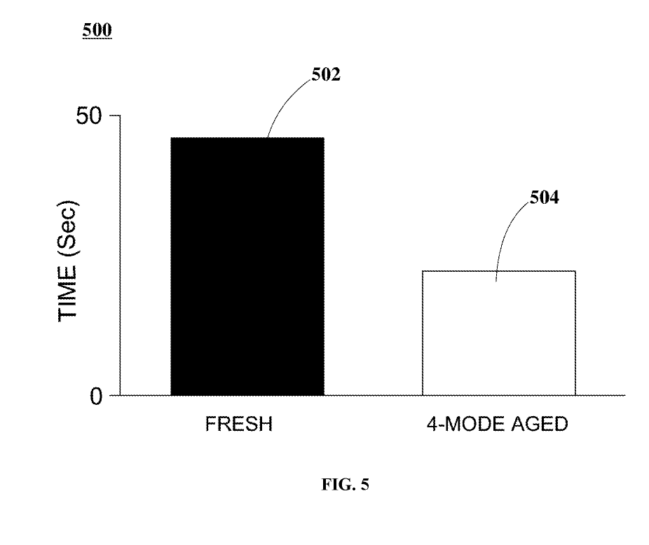

FIG. 5 is a graphical representation illustrating OSC isothermal oscillating test results of CO delay times for fresh and aged ZREM-ZPGM Type 4 OSM system B, at about 525° C. and SV of about 60,000 h⁻¹, according to an embodiment. In FIG. 5, OSC test results 500 include CO delay time bar 502 and CO delay time bar 504.

In some embodiments, CO delay time bar 502 illustrates CO delay time associated with fresh ZREM-ZPGM Type 4 OSM system B. In these embodiments, CO delay time bar 504 illustrates CO delay time associated with aged ZREM-ZPGM Type 4 OSM system B. Further to these embodiments, fresh ZREM-ZPGM Type 4 OSM system B exhibits greater CO delay time when compared with aged ZREM-ZPGM Type 4 OSM system B. Still further to these embodiments, aged ZREM-ZPGM Type 4 OSM system B exhibit greater CO delay time when compared with fresh OSM reference system 2 (including ceria/zirconia-based OSM), thereby confirming higher thermally stability as well as catalytic activity for ZREM-ZPGM Type 4 OSM system B.

In summary, ZREM-ZPGM Type 4 OSM systems exhibit significantly improved OSC properties as compared to the OSC property associated with the PGM OSM reference system 2. The OSC test results confirm that the improved OSC properties of ZREM-ZPGM Type 4 systems are attributed to the binary spinel oxide of Mn—Fe. The aforementioned results confirm that non-Cu spinel ZREM-ZPGM OSM systems can be employed as OSM within a variety of TWCs.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

1. A catalyst composition comprising a spinel oxide having the formula A_{X}B_{3-X}O₄ where X is from about 0.001 to about 2.99, A and B are different from each other and selected from the group consisting of aluminum (Al), magnesium (Mg), manganese (Mn), gallium (Ga), nickel (Ni), silver (Ag), cobalt (Co), iron (Fe), chromium (Cr), titanium (Ti), tin (Sn), strontium (Sr), and mixtures thereof, and wherein the composition is characterized by the absence of a copper (Cu) containing spinel.

2. The composition of claim 1, wherein the catalyst composition is free of platinum group metals.

3. The composition of claim 1, wherein the catalyst composition is free of rare earth metals.

4. The composition of claim 1, wherein the spinel oxide is selected from the group consisting of Co—Fe binary spinel structures, Fe—Mn binary spinel structures, Co—Mn binary spinel structures, Mn—Fe binary spinel structures, and combinations thereof.

5. The composition of claim 4, wherein the spinel oxide is Co_{0.2}Fe_{2.8}O₄.

6. The composition of claim 4, wherein the spinel oxide is Fe_{1.0}Mn_{2.0}O₄.

7. The composition of claim 4, wherein the spinel oxide is Co_{1.0}Mn_{2.0}O₄.

8. The composition of claim 4, wherein the spinel oxide is Mn_{0.5}Fe_{2.5}O₄.

9. The composition of claim 1, wherein the catalyst composition exhibits a CO delay time that is between 10 and 45 seconds.

10. The composition of claim 1, wherein the catalyst composition exhibits an O₂ delay time that is between 25 and 40 seconds.

11. The composition of claim 1, wherein the composition is prepared via co-precipitation, nitrate combustion, impregnation, sol-gel, or incipient wetness.

12. A catalyst system comprising:
a substrate;
at least one washcoat layer deposited onto the substrate, the washcoat layer comprising a support oxide material;
at least on overcoat layer overlying the at least one washcoat layer, the overcoat layer comprising a support oxide material; and
an impregnation layer that is at least partially impregnated onto an underlying overcoat layer, the impregnation layer comprising a catalyst composition comprising a spinel oxide having the formula A_{X}B_{3-X}O₄ where X is from about 0.001 to about 2.99, A and B are different from each other and selected from the group consisting of aluminum (Al), magnesium (Mg), manganese (Mn), gallium (Ga), nickel (Ni), silver (Ag), cobalt (Co), iron (Fe), chromium (Cr), titanium (Ti), tin (Sn), strontium (Sr), and mixtures thereof, and wherein the composition is characterized by the absence of copper (Cu) containing spinel.

13. The catalyst system of claim 12, wherein the spinel oxide is selected from the group consisting of Co—Fe binary spinel structures, Fe—Mn binary spinel structures, Co—Mn binary spinel structures, and combinations thereof.

14. The catalyst system of claim 12, wherein the spinel oxide is selected from the group consisting of Co_{0.2}Fe_{2.8}O₄, Fe_{1.0}Mn_{2.0}O₄, Co_{1.0}Mn_{2.0}O₄, and combinations thereof.

15. The catalyst system of claim 12, wherein the catalyst composition is free of platinum group metals, and is free of rare earth metals.

16. The catalyst system of claim 12, wherein the support oxides in the at least one overcoat layer and the at least one washcoat layer are selected from the group consisting of Al₂O₃, doped Al₂O₃, ZrO₂, doped ZrO₂, SiO₂, doped SiO₂, TiO₂, doped TiO₂, doped Al₂O₃—ZrO₂, and mixtures thereof.

17. The catalyst system of claim 12, wherein the support is doped with an oxide selected from the group consisting of La₂O₃, CeO₂, Pr₂O₃, TiO₂, Nb₂O₃, and mixtures thereof.

18. The catalyst system of claim 12, wherein the washcoat layer comprises doped Al₂O₃, the overcoat layer comprises doped Zr₂O₂, and the spinel oxide is Co_{0.2}Fe_{2.8}O₄.

19. The catalyst system of claim 12, wherein the washcoat layer comprises doped Al₂O₃, the overcoat layer comprises doped Zr₂O₂, and the spinel oxide is Fe_{1.0}Mn_{2.0}O₄.

20. The catalyst system of claim 12, wherein the washcoat layer comprises doped Al₂O₃, the overcoat layer comprises doped Zr₂O₂, and the spinel oxide is Co_{1.0}Mn_{2.0}O₄.

21. The catalyst system of claim 12, wherein the catalyst system exhibits a CO delay time that is between 10 and 25 seconds, and an O₂ delay time that is between 25 and 40 seconds.

22. The catalyst system of claim 12, wherein the catalyst system exhibits a CO delay time that is between 11 and 25 seconds, and an O₂ delay time that is between 27 and 39 seconds.

23. A catalyst composition comprising a Mn—Fe binary spinel oxide composition that is characterized by the absence of a copper (Cu) containing spinel.

24. The catalyst composition of claim 23, wherein the Mn—Fe binary spinel oxide is Mn_{0.5}Fe_{2.5}O₄.

25. The catalyst composition of claim 23, wherein the catalyst composition comprises a mixture of the Mn—Fe binary spinel oxide and a doped Al₂O₃—ZrO₂ support oxide.

26. The catalyst composition of claim 24, wherein the catalyst composition exhibits a CO delay time that is between 24 and 38 seconds.
